(19) United States
(12) Patent Application Publication
(10) Pub. No.: US 2009/0064434 A1
(43) Pub. Date: Mar. 12, 2009

(54) Painting tools

(76) Inventor: John Mallaridas, Lansdown, PA (US)

Correspondence Address: ETHAN D. CIVAN, 170 SOMERSET DRIVE, BLUE BELL, PA, 19422, US

(21) Appl. No.: 11/899,487

(22) Filed: Sep. 6, 2007

(51) Int. Cl. B25G 1/04; B05C 17/02; B25G 1/06; B25G 1/00

(52) U.S. Cl. 15/144.4; 15/144.3; 15/145; 15/210.1

(57) ABSTRACT

A painting rig handle, including a first prong; and a second prong, wherein the first prong and the second prong are capable of being removably attached to the opposing ends of a nap.

### FIELD OF THE INVENTION

The present invention relates to painting tools.

### BACKGROUND

Roller paint brushes are extremely useful for painting large surfaces quickly; however, they are very messy to clean. Prior art roller paint brushes must generally be unscrewed in order for the roller portion to be removed. Subsequently, the roller portions must often be pulled from the handle or “cage frame” portions of the brushes before the roller portions can be cleaned. A paint brush frame allowing the roller portion to be disengaged for cleaning quickly and with a minimum of contact with the roller portion would therefore be desirable.

Roller paint brushes are manufactured in a limited number of sizes. Nevertheless, paint jobs and painters come in a variety of sizes. A universal system allowing painters to use interchangeable roller paint brush parts of varying sizes would therefore be desirable.

### SUMMARY OF THE INVENTION

A painting rig handle, including a first prong; and a second prong, wherein the first prong and the second prong are capable of being removably attached to the opposing ends of a nap.

### BRIEF DESCRIPTION OF THE DRAWINGS

FIG. 1 is an illustration of a first embodiment of the present invention.

FIG. 2 is an illustration of a portion of a second embodiment of the present invention.

FIG. 3 is an illustration of an alternate view of a portion of a second embodiment of the present invention.

FIG. 4 is an illustration of a first component of a third embodiment of the present invention.

FIG. 5 is an illustration of a second component of a third embodiment of the present invention.

FIG. 6 is an illustration of a component usable in conjunction with the present invention.

FIG. 7 is an illustration of a component usable in conjunction with the present invention.

FIG. 8 is an illustration of a component usable in conjunction with the present invention.

FIG. 9 is an illustration of a component usable in conjunction with the present invention.

FIG. 10 is an illustration of a fourth embodiment of the present invention.

FIG. 11 is a second illustration of a fourth embodiment of the present invention.

FIG. 12 is an illustration of a fifth embodiment of the present invention.

FIG. 13 is an illustration of a sixth embodiment of the present invention.

FIG. 14 is an illustration of a seventh embodiment of the present invention.

FIG. 15 is an illustration of an eighth embodiment of the present invention.

### DETAILED DESCRIPTION OF THE PREFERRED EMBODIMENTS

The following definitions are provided to aid in construing the claims of the present application:

Nap: For purposes of the present application, a generally cylindrical tool for applying paint to a surface, sometimes referred to as a roller cover, but not including any apparatus for holding the nap (such as the painting rig handle). A nap's surface can include natural, synthetic, or a blend of natural and synthetic materials, depending on the surface to be painted. The length of the fibers can similarly vary. A nap can (but need not) be hollow and can (but need not) include end caps at each of the opposing ends.

Painting Rig Handle: A tool for holding a nap and allowing it to turn when used for painting a surface, sometimes referred to as a roller cage frame.

Quick Removal: For purposes of the present application, a painting rig handle having a nap that can be removed without unscrewing any portion of the painting rig handle.

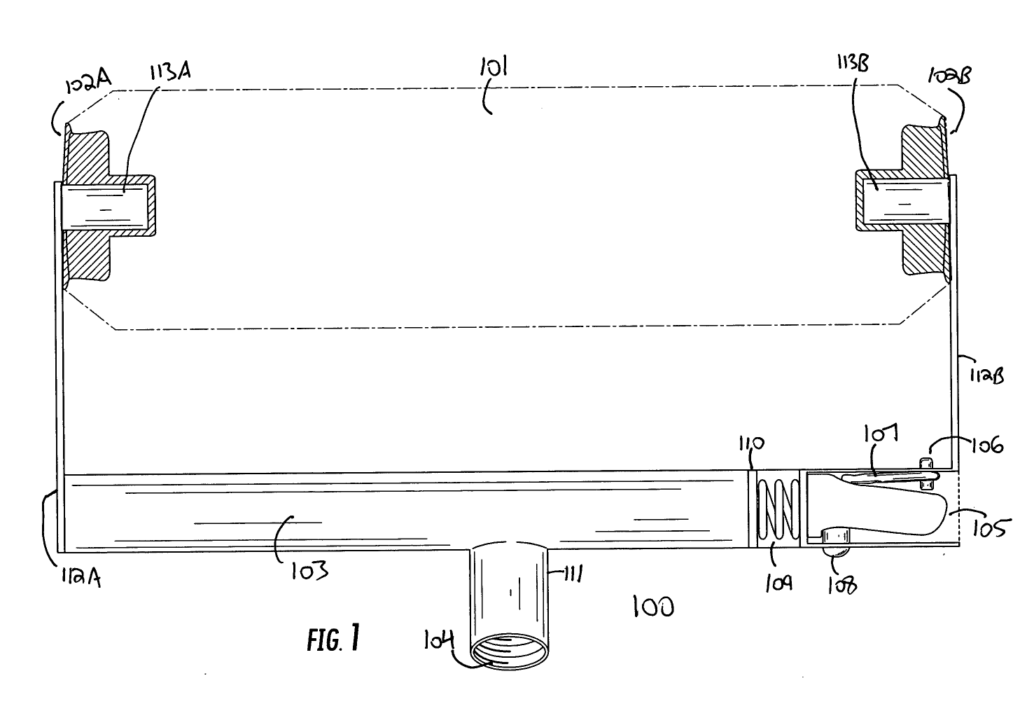

Referring to FIG. 1, in a first preferred embodiment, painting rig handle 100 is illustrated. Nap 101 can be inserted into painting rig 100. Nap 101 can be any commercially available or custom nap, limited only by the dimensions of painting rig handle 100. Painting rig handle 100 can be constructed to accommodate naps of the length of seven inches (7″), nine inches (9″), ten inches (10″), twelve inches (12″), eighteen inches (18″), twenty-one inches (21″), twenty-four inches (24″), twenty-seven inches (27″), thirty inches (30″), thirty-six inches (36″), or any other length desired. End caps 102A and 102B fit snugly into the ends of nap 101. End caps 102A and 102B can be constructed of plastic, metal (such as aluminum), or other materials. In other embodiments, other components or devices can be substituted for end caps 102A and 102B for the purpose of holding nap 101. For example, devices can clamp onto the walls of the ends of nap 101 in multiple locations in order to hold nap 101 steady.

Cross-bar 103 serves as a base of painting rig handle 100 in some embodiments of the present invention. The length of cross-bar 103 depends on the length of the nap that the particular painting rig handle is intended to accommodate. In other embodiments, cross-bar 103 is omitted and other components are connected directly to each other. Cross-bar 103 is preferably constructed of a strong and light material such as aluminum, certain plastics, or wood. In certain embodiments hereunder, handle attachment location 104 allows a handle to be attached. Handle attachment location 104 can be a circular thread allowing poles of varying length to be screwed into handle attachment location 104. In other embodiments hereunder, handle attachment location 104 is omitted and instead a handle is permanently attached to painting rig handle 100.

End cap 105 is a hollow cylinder or other component capable of fitting snugly within the end of cross-bar 103 but sliding partially out of cross-bar 103 in the direction of painting rig prong 112B (described below). When end cap 105 slides out of cross-bar 103, it causes cross-bar 103 to become slightly wider, such as two to six inches or in some cases approximately four inches wider without becoming detached or misaligned from cross-bar 103. End cap 105 also holds spring 109 in place. Screw 106 is a screw or ribbit that holds end cap 105 in place and prevents it from sliding entirely out of cross-bar 103 (in combination with slotted groove 107 described below). Instead of screw 106, the end cap or hollow or malleable cylindrical component can be attached by other means, such as gluing, welding, etc., or by combining multiple components into a single piece. Slotted groove 107 is located in end cap 105 and prevents end cap 105 from becoming detached from cross-bar 103 by allowing screw 106 to move only within slotted groove 107, thereby controlling the movement of the attached end cap 105.

Button 108 is a button that is fitted to push into end cap 105. Button 108 is preferably located on the underside of cross-bar 103 and can be constructed of metal, plastic, or other materials. Spring 109 is located in cross-bar 103 abutting end cap 105. Spring 109 can be any commercially available spring that will fit within the space available, but is preferably tested to ensure that it has the adequate properties for the particular embodiment: sufficient strength to force open the painting rig handle without excessive strength causing the painting rig handle to open with excessive force and sufficient durability to last a reasonable length of time. Wall 110 is a fixed wall within cross-bar 103 permanently holding spring 109 in place on one side. Wall 110 can be constructed of metal, plastic, or other materials and is attached to both cross-bar 103 and spring 109. Shaft 111 is a short handle extending from cross-bar 103 and is omitted in some embodiments of the present invention. Handle attachment location 104 is located at the end of shaft 111. Shaft 111 is preferably constructed of the same materials as cross-bar 103.

Painting rig prong 112A is attached to cross-bar 103 and painting rig prong 112B is attached to end cap 105. Painting rig prongs 112A and 112B can be constructed of any strong lightweight material, such as aluminum, other metals, certain plastics, or other materials. Painting rig prongs 112A and 112B can be approximately four inches in length and from one-half inch to one inch in width in the first preferred embodiment. In other embodiments, other dimensions can be utilized depending on various factors, including the size and type of nap to be utilized. Painting rig prongs 112A and 112B are attached to tubing connections 113A and 113B respectively. Tubing connections 113A and 113B can be constructed of any strong lightweight material, such as aluminum, other metals, certain plastics, or other materials. Tubing connections 113A and 113B can be approximately one inch in length and approximately three-eighths of an inch in radius in the first preferred embodiment. In other embodiments, other dimensions can be utilized depending on various factors, including the size and type of nap to be utilized. Tubing connections 113A and 113B fit snugly into end caps 2A and 2B respectively.

Pushing on button 108 exerts a force on end cap 105 and causes end cap 105 to disengage from cross-bar 103 and slide to the right (without becoming detached) due to the force exerted by spring 109. Because painting rig prong 112B is attached to end cap 105 (and tubing connection 113B is attached to painting rig prong 112B), painting rig handle 100 opens when button 108 is pressed. Nap 101 can then be inserted with tubing connections 113A and 113B fitted into end caps 102A and 102B of nap 101. End cap 105 can then be closed manually causing it to lock into place and button 108 to pop out. Pushing on button 108 again causes painting rig handle 100 to open again, allowing a user to slide nap 101 off painting rig handle 100 in less than five seconds using only one hand (the same hand can hold the painting rig handle, open the painting rig handle, and slide off the nap) without touching the nap.

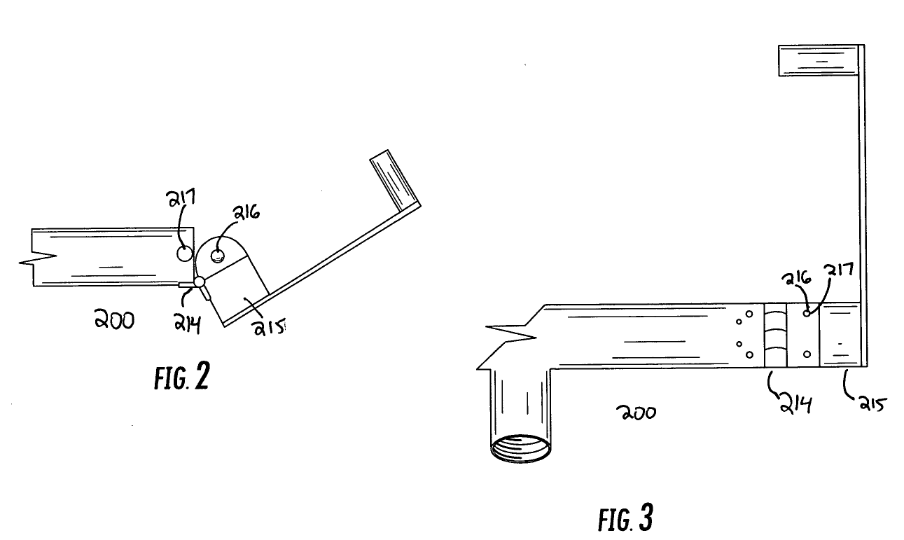

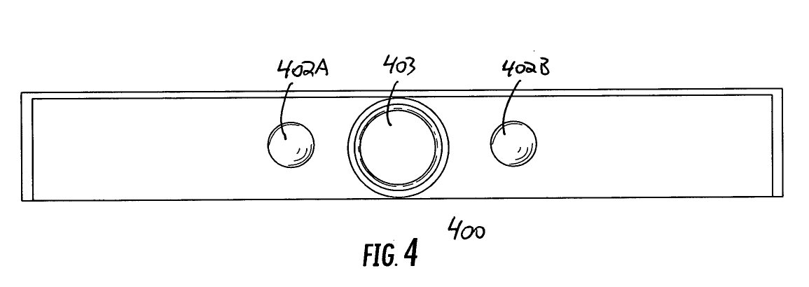

FIGS. 2 and 3 illustrate a portion of a second preferred embodiment of the present invention. The second preferred embodiment is identical to the first preferred embodiment except that slotted end 105, screw 106, slotted groove 107, button 108, spring 109, and wall 110 are omitted. Instead, hinged painting rig handle 200 includes hinge 214, hinged end 215, button 216, and hole 217. Hinge 214 is attached to cross-bar 103 and hinged end 215. Hinge 214 can be any commercially available hinge, such as a metal hinge. Hinged end is a portion of cross-bar 103 that is able to pivot with respect to the main portion of cross-bar 103 as a result of being attached with hinge 214. Hinged end 215 can be constructed of the same material as cross-bar 103. Hinged end 215 is also attached to painting rig prong 112B. Button 216 is attached to hinged end 215. Hole 217 is located in the main portion of cross-bar 103. Button 216 fits through hole 217. Button 216 ordinarily holds hinged end 215 in a closed or locked position, hinged painting rig handle 200 in a closed position and holding any nap located in hinged painting rig handle 200 in place between tubing connections 113A and 113B. When button 216 is pressed, hinge 214 opens and painting rig prong 112B ceases to be perpendicular to cross-bar 103. Hinged painting rig handle 200 can be closed manually, causing button 216 to pop out. FIG. 2 illustrates painting rig handle 200 in an open position and FIG. 3 illustrates painting rig handle 200 in a closed position.

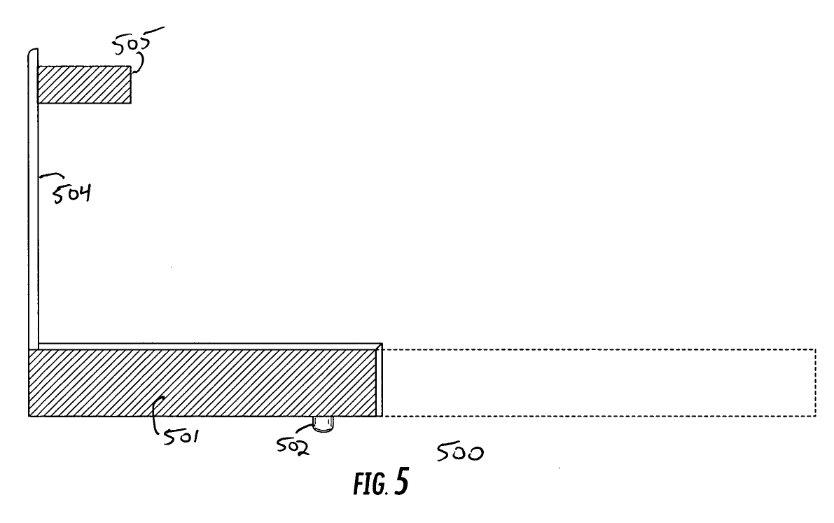

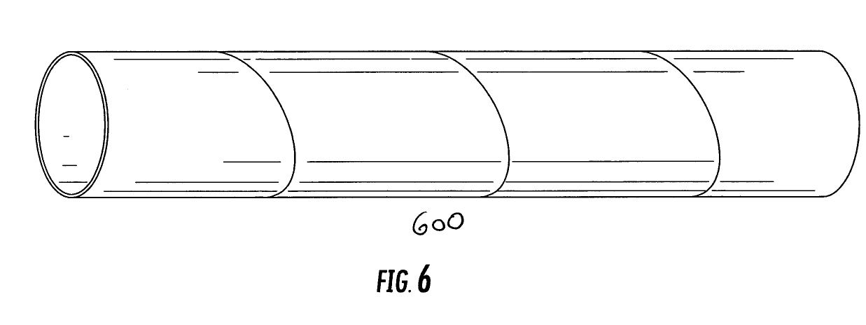

FIGS. 4 and 5 illustrate a third embodiment of the present invention. In FIG. 4, universal painting rig handle 400 can be constructed of a light metal, such as aluminum, plastic, or other materials. Universal painting rig handle 400 is hollow and includes attachment sites 402A and 402B. Attachment sites 402A and 402B can be holes as in the third preferred embodiment, grooves, or other means of attachment. Universal painting rig handle 400 also includes handle attachment location 403 in the third preferred embodiment. Handle attachment location 403 can be a thread for screwing in a threaded handle. Alternatively, a handle can be permanently affixed to universal painting rig handle 400 (although utilizing handle attachment location 403 allows handles of different lengths to be interchanged for different tasks and allows universal painting rig handle 400 to be disassembled for efficient storage). Handle attachment location 403 is located in the middle of universal painting rig handle 400 in the third preferred embodiment for maximum stability and attachment sites are located symmetrically on either side of handle attachment location 403.

FIG. 5 illustrates rig end 500, including interior end 501, button 502, painting rig prong 504, and tubing connector 505. Tubing connector 505 is identical to tubing connectors 113A and 113B in FIG. 1 and is attached to painting rig prong 504, which is identical to painting rig prongs 112A and 112B in FIG. 1. Interior end 501 can be constructed of a light metal, such as aluminum, plastic, or other materials and is preferably constructed so as fit snugly into universal painting rig handle 400 and slide smoothly into and out of universal painting rig handle 400. Button 502 is constructed of such a size as to fit snugly into hole 402A or 402B and located on painting rig prong so as to be aligned with hole 402A or 402B when painting rig prong is inserted into universal painting rig handle 400.

It is intended that two rig ends 500 (of the same size) will be used together with one universal painting rig handle 400 so as to create a single painting rig handle similar to that of FIG. 1 (although utilizing a different disengagement mechanism). It is envisioned that rig ends of different lengths will be manufactured, such as seven inches (7″), nine inches (9″), ten inches (10″), twelve inches (12″), eighteen inches (18″), twenty-one inches (21″), twenty-four inches (24″), twenty-seven inches (27″), thirty inches (30″), thirty-six inches (36″), and other lengths, so that a user can snap in and out rig ends of different lengths without needing to change any other portion of the system.

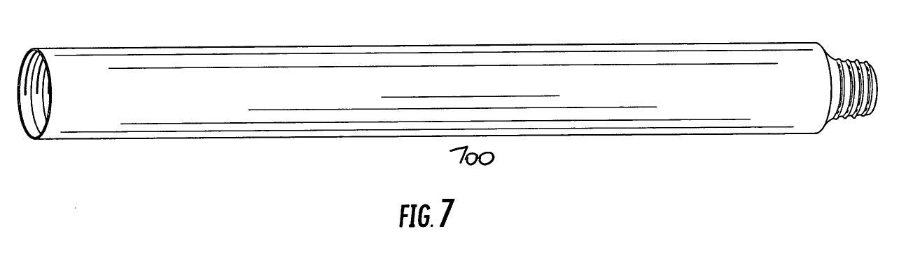

Referring to FIG. 6, a cylindrical insert 600 is illustrated. Cylindrical insert 600 can be a piece of plastic tubing of length and diameter depending on its use. Cylindrical insert 600 is utilized to join together two commercially available naps to create a larger nap than is currently available on the market. Cylindrical insert 600 must fit snugly inside the naps to be joined together. For example, an eighteen inch (18″) nap and a nine inch (9″) nap can be joined together using an approximately ten inch (10″) long cylindrical insert 600 to form a twenty-seven inch (27″) nap or two eighteen inch (18″) naps can be joined together using an approximately ten inch (10″) long cylindrical insert 600 to form a thirty-six inch (36″) nap. Similarly, an eighteen inch (18″) nap can be joined with a twelve inch (12″) nap to form a thirty inch (30″) nap, two twelve inch (12″) naps can be joined to form a twenty four inch (24″) nap, a twelve inch (12″) nap can be joined with a nine inch (9″) nap to form a twenty-one inch (21″) nap, etc. Surprisingly, the inventor has found that although after a single stroke the combined nap leaves a gap in the center, no gaps or imperfections are discernible in areas painted with the combined naps despite the tapered edges of many naps after as few as two strokes. Thus, a large area can be painted far more efficiently.

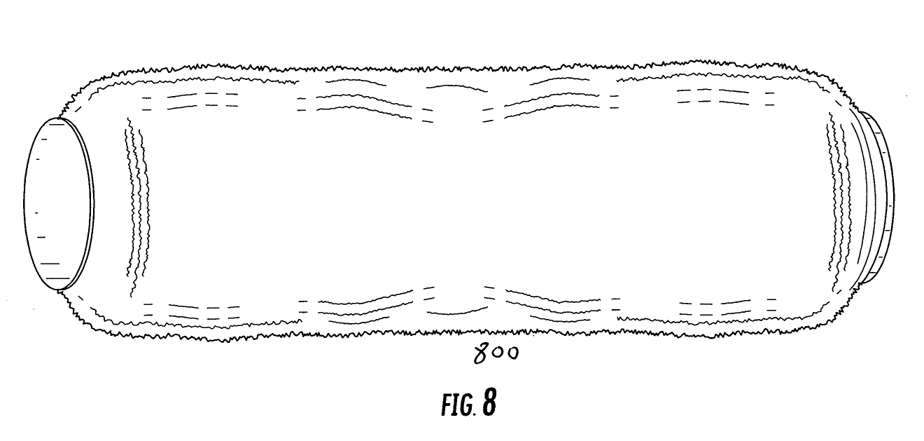

FIG. 7 illustrates a handle 700 that can be screwed into any of the painting rig handles of the present invention. The handle 700 can be constructed of aluminum, wood, or other materials and can have a threaded end for screwing into a handle attachment location. The handle 700 can be twelve inches (12″) in length, but in some embodiments, handles of differing lengths are utilized.

FIG. 8 illustrates a nap 800 for a painting rig handle.

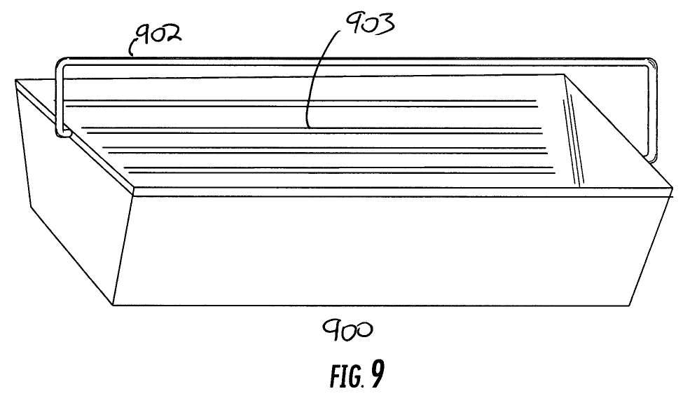

FIG. 9 illustrates a painting bucket 900, which preferably includes a handle 902, and grooves 903 for straining excess paint from a nap. Painting bucket 900 is preferably approximately thirty-seven inches (37″) long to allow thirty-six inch (36″) naps to inserted into it, approximately ten inches (10″) high, approximately ten inches (10″) wide in back and approximately twelve inches (12″) wide in front to maximize the amount of amount of paint in the bucket while minimizing weight.

FIG. 10 illustrates telescopic painting rig handle 1000. Cross-bar 1001 includes a plurality of holes 1004. Cross-bar can be a hollow metal, plastic, or other tube having a right interior tube 1002A and a left interior tube 1002B and optionally a right deep interior tube 1003A and a left deep interior tube 1003B constructed so as to slide telescopically within each of the right and left sides respectively of cross bar 1001. Right and left interior tubes 1002A and 1002B each include a button, 1005A and 1005B respectively, capable of fitting snuggly within the holes 1004 in cross-bar 1001. If right and left deep interior tubes 1003A and 1003B are utilized, then right and left interior tubes 1002A and 1002B each have a plurality of holes 1006 and right and left deep interior tubes 1003A and 1003B each have a button, 1007A and 1007B respectively, capable of fitting snuggly within the holes in right and left interior tubes 1002A and 1002B. Right and left interior tubes 1002A and 1002B and right and left deep interior tubes 1003A and 1003B can be constructed of the same materials as cross-bar 1001.

Telescopic painting rig handle 1000 includes painting rig prongs 1012A and 1012B attached to the ends of right and left deep interior tubes 1003A and 1003B respectively if utilized, otherwise to the ends of right and left interior tubes 1002A and 1002B respectively. Painting rig prongs 1012A and 1012B are identical to painting rig prongs 112A and 112B in FIG. 1. Tubing connectors 1013A and 1013B are attached to painting rig prongs 1012A and 1012B respectively and are identical to tubing connectors 113A and 113B in FIG. 1. Handle attachment location 1011 is attached to cross-bar 1001 and is identical to handle attachment location 111 in FIG. 1.

When telescopic painting rig handle 1000 is in a fully closed position, pressing on a button 1005A or 1005B causes cross-bar 1001 to disengage from right or left interior tube 1002A or 1002B as may be applicable and slide from the first to the send of the holes 1004 in cross-bar 1001, causing telescopic painting rig handle 1000 to open up one position, allowing a nap to be inserted or removed. The button can then be depressed again while the telescopic painting rig handle is pushed back towards its initial position to close and lock the telescopic painting rig handle. Alternatively, both buttons 1005A and 1005B can be depressed and the telescopic painting rig handle can be converted into a larger painting rig handle. This can be done repeatedly until no more holes remain. If left and right deep interior tubes 1003A and 1003B are utilized, at this point, left and right deep interior tubes 1003A and 1003B will slide out and the buttons on right and left interior tubes 1002A and 1002B can be used similarly to extend right and left deep interior tubes 1003A and 1003B. It is intended that the widest setting on the telescopic painting rig handle be wider than the setting for the widest nap intended to be used in the telescopic painting rig handle in order to allow easy nap removal at all settings. In some embodiments, the telescopic painting rig handle includes positions for naps of six inches (6″), seven inches (7″), nine inches (9″), ten inches (10″), twelve inches (12″), fourteen inches (14″), sixteen inches (16″), and eighteen inches (18″). In other embodiments, a vice or clamping system is utilized and any position from six inches to eighteen inches or from six inches (6″) to thirty-six inches (36″) can be utilized.

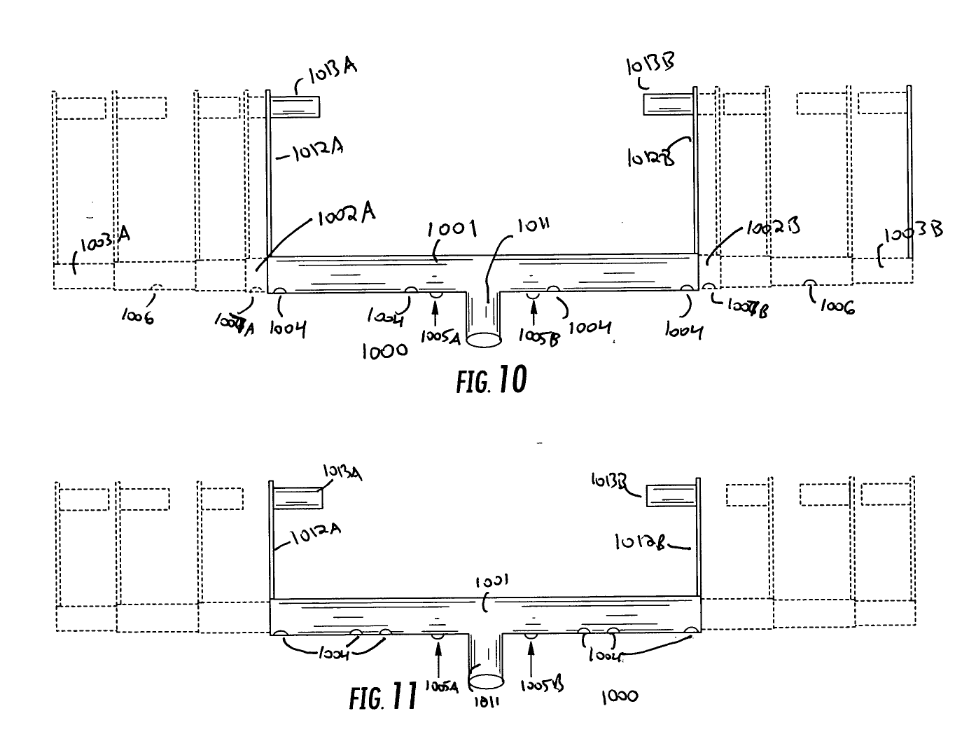

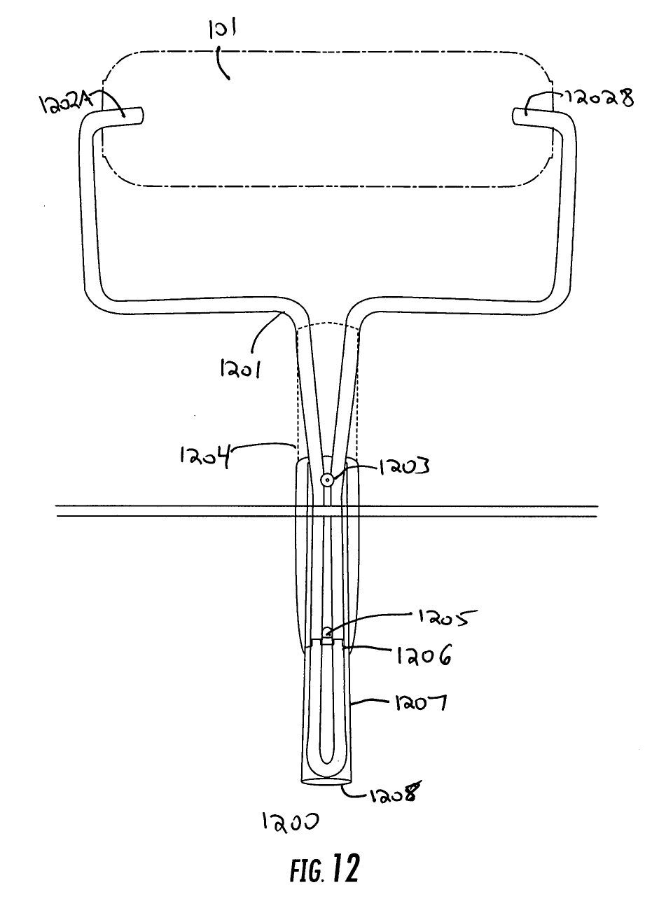

FIG. 11 illustrates a telescopic painting rig handle without right and left deep interior tubes 1003A and 1003B. In all other respects, it is identical to FIG. 10. In other embodiments of the present invention, a telescopic paint rig handle including two, three, or more deep interior tubes can be utilized. In addition, different numbers of deep interior tubes can be utilized on the right and left sides of the painting rig handle.

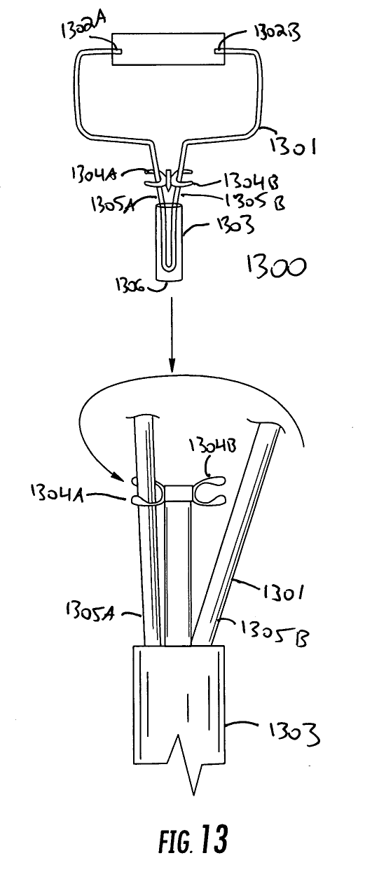

Referring to FIG. 12, a fifth embodiment of the present invention is illustrated. Flexible painting rig handle 1200 includes frame 1201, frame prongs 1202A and 1202B, button 1203, tube 1204, hole 1205, mini-prongs 1206, handle 1207, and handle attachment location 1208. Frame 1201 is constructed of a lightweight material, such as aluminum, plastic, or other materials and can be (but need not be) rounded in shape. In the fifth preferred embodiment aluminum is utilized. Frame 1201 can be designed to accommodate a variety of different size naps, depending on its size, such as seven inch (7″), nine inch (9″), ten inch (10″) and twelve inch (12″) naps. In the fifth preferred embodiment, the handle 1207 of the frame 1201 is approximately eight inches (8″) in length and the entire frame 1201 is approximately fifteen inches (15″) in length; however, other dimensions can be utilized in other embodiments hereunder. Frame 1201 is generally shaped so as to form a frame capable of accommodating a nap and having a handle. Frame 1201 can resemble the frame illustrated in FIG. 12 in shape or can possess a different shape so long as frame prongs 1202A and 1202B (described below) can be inserted into nap 101 and frame 1201 possesses an appropriate handle 1207.

The ends of frame 1201 form frame prongs 1202A and 1202B, which perform the same function as tubing connectors 113A and 113B in FIG. 1. Frame prongs 1202A and 1202B can be approximately one inch in length, although in some embodiments their lengths can vary. Frame prongs 1202A and 1202B can be of varying radii depending on a variety of factors, including the size of the space in the end caps into which they are inserted in nap 101.

Button 1203 is located on handle 1207. Button hole 1204 is located in tube 1205 which fits over handle 1207 and slides up and down handle 1207. Tube 1205 can be constructed of metal (such as aluminum), plastic, or other materials. Button 1203 fits snugly within button hole 1204. By sliding tube 1205 up until button 1203 fits into button hole 1204, button 1203 holds tube 1205 in a locked position and tube 1205 forces frame prongs 1202A and 1202B inwards towards each other holding a nap 101 in a closed or locked position. Pressing button 1203 and sliding tube 1205 part of the way down handle 1207 causes the pressure that formerly forced frame prongs 1202A and 1202B towards each other to be released and allows frame prongs 1202A and 1202B to move away from each other, allowing nap 101 to be released from flexible painting rig 1200. Thus, flexible painting rig handle 1200 can be opened with one hand in less than five seconds without the need to touch nap 101. Mini-prongs 1206 are optionally attached to tube 1205 in order to allow flexible painting rig 1200 to be hooked to the side of a bucket or pan. Handle attachment location 1208 is attached to handle 1207 and is identical to handle attachment location 111 in FIG. 1. Because flexible painting rig handle 1200 can be a very light painting rig handle it is particularly suitable for painting walls.

Referring to FIG. 13, a sixth embodiment of the present invention is illustrated. Clipping painting rig handle 1300 includes frame 1301, frame prongs 1302A and 1302B, handle 1303, clips 1304A and 1304B, frame prongs 1305A and 1305B, and handle attachment location 1306. Frame 1301 is constructed of a lightweight material, such as aluminum, plastic, or other materials and can be (but need not be) rounded in shape. In the sixth preferred embodiment aluminum is utilized. Frame 1301 can be designed to accommodate a variety of different size naps, depending on its size, such as seven inch (7″), nine inch (9″), ten inch (10″) and twelve inch (12″) naps. In the sixth preferred embodiment, the handle 1303 of the frame 1301 is approximately eight inches (8″) in length and the entire frame 1301 is approximately fifteen inches (15″) in length; however, other dimensions can be utilized in other embodiments hereunder. Frame 1301 is generally shaped so as to form a frame capable of accommodating a nap and having a handle. Frame 1301 can resemble the frame illustrated in FIG. 13 in shape or can possess a different shape so long as frame prongs 1302A and 1302B (described below) can be inserted into nap 101 and frame 1301 possesses an appropriate handle 1303.

The ends of frame 1301 form frame prongs 1302A and 1302B, which perform the same function as tubing connectors 113A and 113B in FIG. 1. Frame prongs 1302A and 1302B can be approximately one inch in length, although in some embodiments their lengths can vary. Frame prongs 1302A and 1302B can be of varying radii depending on a variety of factors, including the size of the space in the end caps into which they are inserted in nap 101.

Frame prongs 1302A and 1302B form independent portions of frame 1301 connected to handle 1303. Clips 1304A and 1304B are connected to handle 1303. When frame prongs 1302A and 1302B are placed into clips 1304A and 1304B respectively, each of the clips exerts a force on its respective frame prong causing it to bend inward, which forces the clipping painting rig handle 1300 into a closed or locked position capable of holding a nap 101. Unclipping a frame prong allows that frame prong to return to its natural position, bent at a slight angle away from that necessary to close or lock the clipping painting rig handle, thus allowing any nap 101 to slide out of the clipping painting rig handle. Thus, clipping painting rig handle 1300 can be opened with one hand in less than five seconds without the need to touch nap 101. Of course, in place of clips, other attachment mechanisms, such as grooves can be utilized. Handle attachment location 1306 is attached to handle 1303 and is identical to handle attachment location 111 in FIG. 1. Because clipping painting rig handle 1300 can be a very light painting rig handle it is particularly suitable for painting walls. Clipping painting rig handle 1300 is illustrated in both an open and a closed position in FIG. 13.

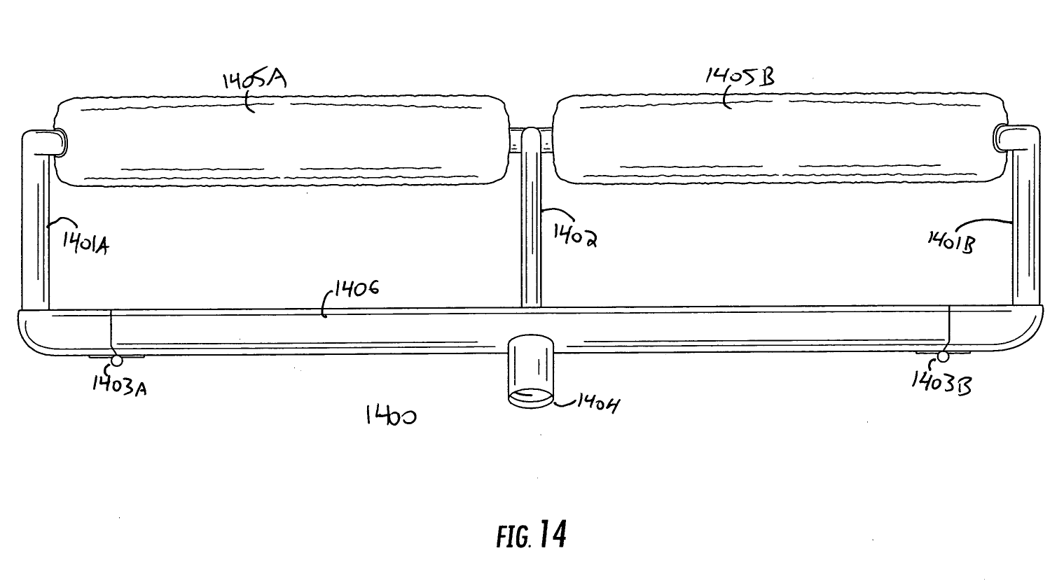

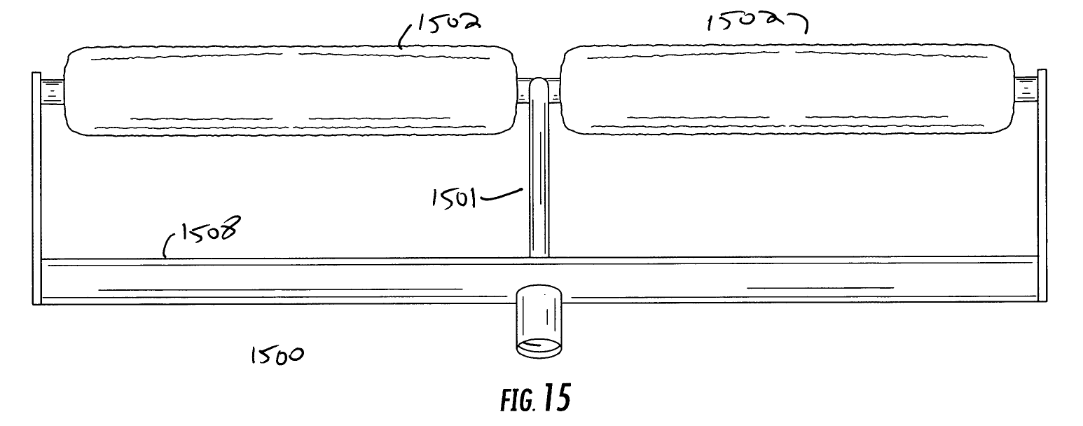

Referring to FIG. 14, a seventh embodiment is illustrated. Double painting rig handle 1400 includes frame 1406, side prongs 1401A and 1401B, center prong 1402, buttons 1403A and 1403B, and handle attachment location 1404. Naps 1405A and 1405B are also illustrated. Frame 1400, side prongs 1401A and 1401B, center prong 1402, buttons 1403A and 1403B, and handle attachment location 1404 can all be constructed of metal (such as a light metal such as aluminum), plastic, or other materials. Center prong 1402 is fixed in the seventh embodiment. Each of buttons 1403A and 1403B operates to open one of side prongs 1401A or 1401B (respectively) using the mechanism described in connection with FIG. 1 in this seventh embodiment, the mechanism described in connection with FIG. 2 above, or some other mechanism. By opening or closing each of the two side prongs, the two naps can be easily inserted or removed separately. The seventh embodiment is particularly useful where it is desired to use two large naps together, such as two eighteen inch (18″) naps to form a thirty-six inch (36″) nap.

All of the painting rig handles described in the present invention, including the painting rig handle described in connection with FIG. 1, the second painting rig handle described in connection with FIGS. 2 and 3, the universal painting rig handle described in connection with FIGS. 4 and 5, the telescopic painting rig handle described in connection with FIGS. 10 and 11, the flexible painting rig handle described in connection with FIG. 12, the clipping painting rig handle described in connection with FIG. 13, the double painting rig handle described in connection with FIG. 14, and the buttressed painting rig handle described in connection with FIG. 15, can include a bend in the handle attachment location. This bend causes any pole that is attached to the handle attachment location to be attached at an angle. Different rig handles can have different angles to accommodate different needs. Placing the bend in handle attachment location, rather than in the pole or in a separate connector avoids the problem that a thread may be difficult to fully tighten leaving a pole misaligned at an undesirable angle.

FIG. 15 illustrates an eighth embodiment. Buttressed painting rig handle 1500 is identical to painting rig handle 100 except that it includes a central support 1501 attached to frame 1508 on which nap 1502 can rest if it buckles. Central support 1501 is preferably flat or gently curved so as to allow nap 1502 to rotate freely while providing support. This eighth embodiment is particularly useful when nap 1502 is very large, such as when two eighteen inch (18″) naps are combined to form a thirty-six inch (36″) nap.

The present invention is not limited to English or U.S. measurements, but applies equally to metric measurements (e.g., a twenty centimeter nap) and applies both to U.S. standards and to Canadian, European, and other international and foreign standards.

The present invention may be embodied in other specific forms without departing from the spirit or essential attributes of the invention. Accordingly, reference should be made to the appended claims, rather than the foregoing specification, as indicating the scope of the invention.

That which is claimed is:

1. A painting rig handle, comprising:
A first prong; and
A second prong,
wherein said first prong and said second prong are capable of being removably attached to the opposing ends of a nap.

2. The painting rig handle of claim 1, further comprising:
a hinge attached to said first prong,
wherein the nap can be attached and detached when said hinge is in an open position; and
wherein said painting rig handle can be utilized for painting when the nap is attached and said hinge is in a closed position.

3. The painting rig handle of claim 2, further comprising:
a spring attached to said hinge; and
a button connected to said spring,
wherein when said hinge is in a closed position, pushing on said button causes said hinge to open.

4. The painting rig handle of claim 3, wherein when a nap is attached and said hinge is in a closed position, the nap can be removed by the user of said painting rig handle using a single hand without touching the nap.

5. The painting rig handle of claim 3, wherein when a nap is attached and said hinge is in a closed position, the nap is held in position between said first prong and said second prong.

6. The painting rig handle of claim 1, wherein said first prong and said second prong are formed of a single continuous element.

7. The painting rig handle of claim 1, further comprising:
A cross-bar attached to said first prong and to said second prong.

8. The painting rig handle of claim 7, further comprising:
A handle attached to said cross-bar.

9. The painting rig handle of claim 8, wherein said handle is removable.

10. The painting rig handle of claim 7, wherein said painting rig handle is adjustable so that naps of different lengths can be attached.

11. The painting rig handle of claim 10, wherein said first prong and said second prong are detachable.

12. The painting rig handle of claim 10, wherein said cross-bar is telescopic.

13. The painting rig handle of claim 10, wherein a nap of any length between six inches (6″) and thirty-six inches (36″) is attached to said painting rig handle.

14. The painting rig handle of claim 1, wherein a nap of one of the following lengths is attached to said painting rig handle: seven inches (7″), nine inches (9″), ten inches (10″), twelve inches (12″), eighteen inches (18″), twenty-one inches (21″), twenty-four inches (24″), twenty-seven inches (27″), thirty inches (30″) or thirty-six inches (36″).

15. The painting rig handle of claim 1, wherein said painting rig handle is a quick removal painting rig handle.

16. The painting rig handle of claim 1, wherein a nap can be removed from said painting rig handle in less than fifteen seconds.

17. An extended length nap, comprising:
A left nap, having a right end and a left end;
A right nap, having a right end and a left end; and
A connector, attached to said left nap and to said right nap,
wherein the right end of said left nap abuts the left end of said right nap
wherein said extended length nap when utilized for painting does not leave any gaps where said left nap and said right nap abut.
